(19) United States
(12) Patent Application Publication
(10) Pub. No.: US 2007/0085763 A1
(43) Pub. Date: Apr. 19, 2007

(54) Plasma display device with heat sink noise reducer

(76) Inventor: Kwang-Jin Jeong, Yongin-si (KR)

Correspondence Address: CHRISTIE, PARKER & HALE, LLP, PO BOX 7068, PASADENA, CA, 91109-7068, US

(21) Appl. No.: 11/439,629

(22) Filed: May 23, 2006

(30) Foreign Application Priority Data
May 25, 2005 (KR) 10-2005-0044020

(51) Int. Cl. G09G 3/28

(52) U.S. Cl. 345/60

(57) ABSTRACT

A plasma display device to reduce noise generated from heat sinks. A chassis base is attached to a surface of a plasma display panel. A printed circuit board assembly is mounted to the chassis base at a side opposite to the plasma display panel and connected to the plasma display panel. The print circuit board assembly includes one or more circuit elements. A heat sink having a plurality of fins is attached to the one or more circuit elements. A fixing member connects and fixes free ends of the plurality of fins to one another.

### CROSS-REFERENCE TO RELATED APPLICATION

This application claims priority to and the benefit of Korean Patent Application 10-2005-0044020 filed in the Korean Intellectual Property Office on May 25, 2005, the entire content of which is incorporated herein by reference.

### BACKGROUND OF THE INVENTION

The present invention relates to a plasma display device, and more particularly, to a plasma display device in which noise generated from a heat sink is reduced.

A plasma display device is an apparatus that displays an image on a plasma display panel (PDP) using plasma generated by a gas discharge. A PDP sustain driving board and a PDP scan driving board are provided with an intelligent power module (IPM) and a field effect transistor (FET) to control PDP sustain and scan electrodes. However, since the IPM and FET produce a substantial amount of heat during operation, the IPM and the FET are provided with heat sinks to dissipate the heat. The heat sinks also operate as noise sources. That is, the ends of the heat sinks vibrate, thereby generating noise.

### SUMMARY OF THE INVENTION

In accordance with the present invention plasma display device is provided in which noise generated from a heat sink is reduced.

An exemplary plasma display device according to an embodiment of the present invention includes a plasma display panel. A chassis base is attached to a surface of the plasma display panel. A printed circuit board assembly is mounted to the chassis base at a side opposite to the plasma display panel and connects to the plasma display panel. The printed circuit board assembly has one or more circuit elements. A heat sink is attached to the one or more circuit elements. The heat sink has a plurality of fins extending away from the one or more circuit elements. A fixing member connects and fixes free ends of the plurality of fins to one another.

A method of reducing noise generated by a heat sink having heat radiating fins is also provided. Free ends of the heat radiating fins are mounted into engagement grooves of a fixing member such that each of the free ends are fixedly connected with one another.

The fixing member may be mounted to at least a corner of the free ends, and in an exemplary embodiment may be mounted to each corner of the free ends.

The fixing member may also be mounted to the free ends between both corners of the free ends.

The fixing member may include a cover extending in a first direction orthogonal to a lengthwise direction of the fins with partitions formed at intervals along the first direction inside the cover.

At least one corner of a cross section of the cover may be formed in a shape corresponding to a corner of the free ends.

The cross section of the cover may be formed as a right triangle or a quadrilateral.

A gap between the partitions may correspond to a thickness of each fin measured in the first direction.

A thickness of each partition measured in the first direction may correspond to a gap between the fins.

Engagement grooves may be formed between the partitions to be engaged to the free ends of the fins.

The engagement grooves may be formed in a shape corresponding to corners of the free ends.

The fixing member may be formed by injection molding of synthetic resins.

The fixing member may be fitted to the free ends of the fins.

The printed circuit board assembly may include a sustain driving board for controlling sustain electrodes within the plasma display panel.

The printed circuit board assembly may include a scan driving board for controlling scan electrodes within the plasma display panel.

The circuit element may include a field effect transistor or an intelligent power module.

### BRIEF DESCRIPTION OF THE DRAWINGS

FIG. 1 is a partially exploded perspective view showing a plasma display device according to a first exemplary embodiment of the present invention.

FIG. 2 is a schematic diagram showing the operational layout of the plasma display device of FIG. 1.

FIG. 3 is a partially perspective view showing a printed circuit board assembly provided with circuit elements and a heat sink according to an exemplary embodiment of the present invention.

FIG. 4 is a perspective view showing the heat sink according to the exemplary embodiment of FIG. 3.

FIG. 5 is a cross-sectional view along a line V-V of FIG. 4.

FIG. 6 is a perspective view showing a heat sink according to another exemplary embodiment of the present invention.

### DETAILED DESCRIPTION OF THE EMBODIMENTS

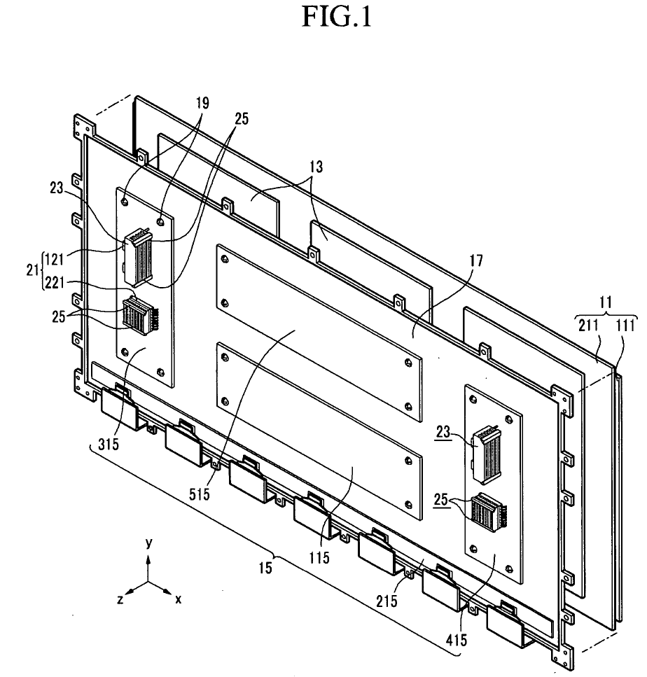

Referring to FIG. 1, a plasma display device according to the first exemplary embodiment of the present invention includes a PDP 11, a chassis base 17, and printed circuit board assemblies (PBAs) 15. The PDP 11 displays an image using a gas discharge. The chassis base 17 is attached to the rear side of the PDP 11. The PBAs 15 are mounted on the rear side of the chassis base 17, and are electrically connected to the PDP 11.

A heat dissipation sheet 13 and a double-sided adhesive tape (not shown) are interposed between the rear side of the PDP 11 and the front side of the chassis base 17. The heat dissipation sheet 13 dissipates heat generated by a gas discharge from the PDP in planar directions (x-y direction in FIG. 1).

The heat dissipation sheet 13 may be made of a heat dissipation material having sufficient thermal conductivity such as acryl, graphite, metal, or carbon nanotubes.

Since the double-sided adhesive tape attaches the PDP 11 to the chassis base 17, the heat dissipation sheet 13 can be disposed close to the rear side of the PDP 11 and the front side of the chassis base 17, respectively.

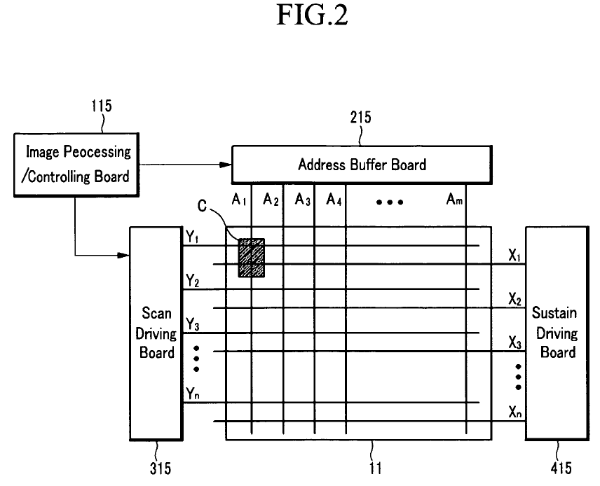

Referring now to both FIG. 1 to FIG. 2, the PDP 11 includes a plurality of address electrodes (A1 to Am, hereinafter referred to as “A”) extending in a column direction, a plurality of sustain electrodes (X1 to Xn, hereinafter referred to as “X”) and scan electrodes (Y1 to Yn, hereinafter referred to as “Y”) extending in a row direction. Each of the sustain electrodes X corresponds to one of the scan electrodes Y, thereby forming a pair.

Specifically, the sustain electrodes X and the scan electrodes Y are arranged on a front substrate 111, and the address electrodes A are arranged on a rear substrate 211.

The front substrate 111 and the rear substrate 211 are attached to each other with discharge spaces therebetween such that the sustain electrodes X and the scan electrodes Y are formed to cross the address electrodes A.

A discharge cell C is formed at a location where the address electrodes A and the sustain electrodes X intersect and the address electrodes A and the scan electrodes Y intersect.

The PBAs 15 that control the PDP 11 are mounted to bosses (not shown) of the chassis base 17 through screws 19. The PBAs 15 include an image processing/controlling board 115, an address buffer board 215, a scan driving board 315, a sustain driving board 415, and a power supply board 515.

The image processing/controlling board among the PBAs 15 receives an external video signal, generates control signals for driving address electrodes and display electrodes (sustain and scan electrodes), and respectively applies them to the address buffer board, the scan driving board, and the sustain driving board. The address buffer board 215 generates address pulses and applies the address pulses to the address electrodes A. The scan driving board 315 generates scan or sustain pulses and applies the scan or sustain pulses to the scan electrodes Y. The sustain driving board generates sustain pulses and applies the sustain pulses to the sustain electrodes X. The power supply board 515 supplies electrical power required for driving the plasma display device.

The PBAs 15 include various circuit elements 21 to control respective electrodes. The circuit elements 21 may produce heat during operation of the PDP 11. Accordingly, heat sinks 23 may be attached to the circuit elements 21.

The heat sinks 23 are attached to the circuit elements 21, to thereby dissipate heat generated from the circuit elements 21. The heat dissipation enables the circuit elements 21 to continuously and properly operate.

The circuit elements 21 to which the heat sinks 23 are attached include a field effect transistor (FET) 121, an intelligent power module (IPM) 221. The heat sinks 23 are attached to a side surface of the FET 121 and an upper surface of the IPM 221.

The FET 121 and the IPM 221 are provided to the scan and sustain driving boards 315 and 415. The FET 121 and the IPM 221 select the scan electrodes Y and the sustain electrodes X according to a reset, an address, and a sustain period, and apply scan pulses and sustain pulses thereto. As a result, the FET 121 and the IPM 221 produce substantial heat.

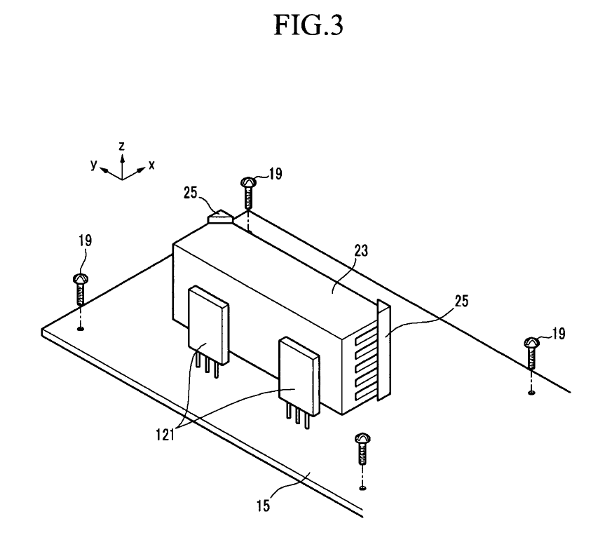

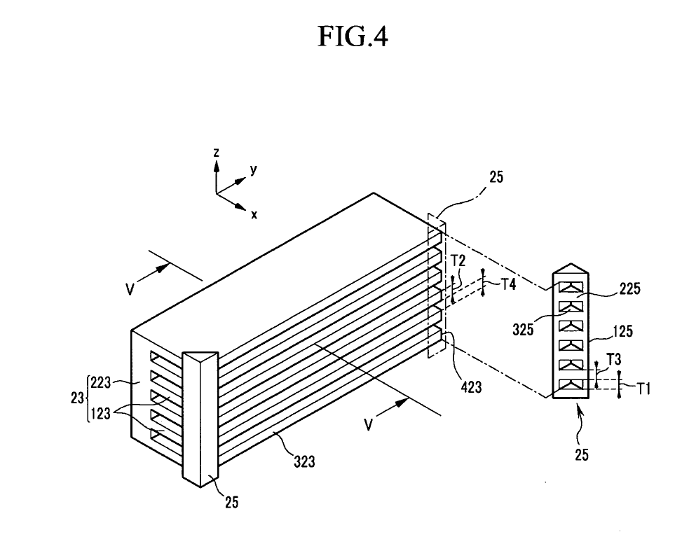

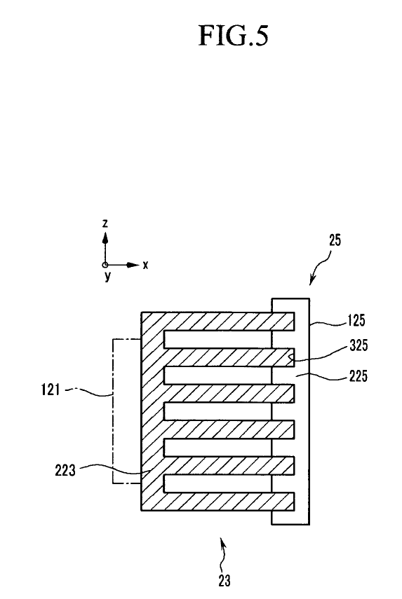

FIG. 3 is a partial perspective view showing a printed circuit board assembly provided with circuit elements and a heat sink according to an exemplary embodiment of the present invention. FIG. 4 is a perspective view showing the heat sink according to the exemplary embodiment of the present invention. FIG. 5 is a cross-sectional view along a line V-V of FIG. 4.

Referring now to FIG. 3 to FIG. 5, the heat sink 23 according to the exemplary embodiment of the present invention includes a plurality of fins 123 to increase heat dissipation areas and a side 223 to which the circuit elements 21 are attached. Ends of the fins 123 are integrally formed with the side 223, and opposite ends of the fins 123 are formed in a shape of a cantilever with free ends 323.

At least one fixing member 25 is mounted to the free ends 323 of the fins 123. That is, a fixing member 25 is mounted to at least a corner 423 of the free ends 323, and is mounted to each corner 423 of the free ends 323 in the exemplary embodiment of the present invention. The fixing member 25 acts as a connecting member that connects the free ends 323 to one another, thereby reducing vibration of the respective fins 123. In the case that fixing members 25 are mounted to both corners 423, the fixing members 25 connect the fins 123 to one another at both corners 423 of the heat sink 23, thereby more effectively reducing the vibration.

In other words, when noise and vibration of the PDP 11 are transferred to the heat sink 23, the noise and the vibration are subsequently transferred to the fixing member 25 through the heat sink 23. However, since the fixing member 25 connects and fixes the fins 123 of the heat sink 23 to one another, the vibration of the individual fins 123 is prevented. As a result, the amplitude of the vibration and the noise transferred to the heat sink 23 decreases.

The fixing member 25 according to the exemplary embodiment of the present invention includes a cover 125 and partitions 225. The cover 125 is formed to extend in a first direction (z-axis direction in FIG. 4) orthogonal to a lengthwise direction of the fins 123. The partitions 225 are formed inside the cover 125, and are arranged at predetermined intervals therebetween along the first direction. In addition, engagement grooves 325 are formed between the partitions 225, and the corners 423 of the free ends 323 are engaged to the engagement grooves 325.

The covers 125 are formed opposite to each other at both corners 423 of the free ends 323. In addition, at least one corner of the cross section of the cover 125 is formed in a shape corresponding to the corners 423 of the free ends 323. In the case that the corners 423 of the free ends 323 are formed at a right angle, one corner of the cross section of the cover 125 is formed at a right angle. In the present embodiment, the cross section of the cover 125 is formed as a right triangle.

The partitions 225 are formed inside the cover 125 at a side facing the fins 123 of the cover 125. When the cross section of the cover 123 is formed as a right triangle, the planar shape of the partitions 225 may be formed as the right triangle. The engagement grooves 325 are formed between the adjacent partitions 225 along the first direction. The engagement grooves 325 are formed in a shape corresponding to the corners 423, and thereby the corners 423 of the free ends 323 are engaged to the engagement grooves 325.

Specifically, a gap T1 between the partitions 225 corresponds to a thickness T2 of the fins 123 measured in the first direction. In other words, a thickness T3 of the partitions 225 measured in the first direction corresponds to a gap T4 between the fins 123. Accordingly, the fixing member 25 can be fitted to the corners 423 of the fins 123, thereby reducing the vibration of the fins 123.

The fixing member 25 can be formed by injection molding of synthetic resins. In this case, the fixing member 25 can be easily manufactured, and be easily engaged to the fins 123 due to elasticity and plasticity.

Because the fixing member 25 may block air flow between the fins 123 of the heat sink 23, the fixing member 25 is preferably formed to have a minimum width and thickness to connect the fins 123. By this configuration, the reduction of heat dissipation efficiency of the heat sink 23 can be minimized.

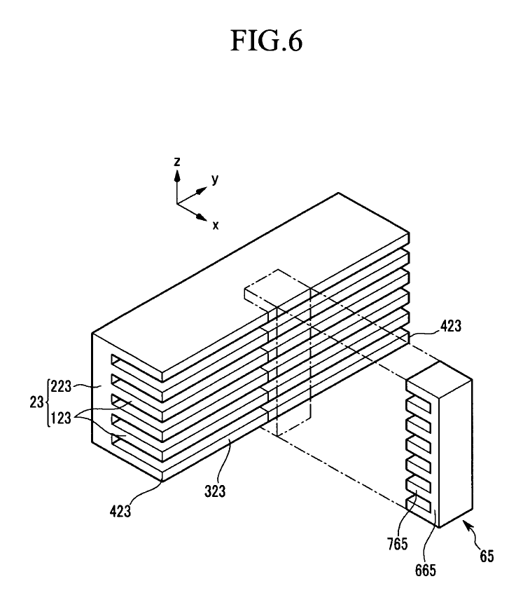

FIG. 6 is a perspective view showing a heat sink according to another exemplary embodiment of the present invention. Because the fixing member according to the new embodiment has a structure and function similar to the fixing member according to the previous embodiment, only the differences between the embodiments will be explained.

Referring to FIG. 6, a fixing member 65 according to the second exemplary embodiment of the present invention is mounted to the free ends 323 between both corners 423. In addition, a cross section of the cover 665 is formed as a quadrilateral, and a planar shape of partitions 765 is also formed as a quadrilateral. The fixing member 65 according to the present embodiment is engaged with the free ends 323 of the fins 123, thereby preventing the vibration of the fins 123 and reducing noise from the fins 123.

In the plasma display device according to exemplary embodiments of the present invention, heat sinks are provided to IPMs or FETs on PBAs, and a fixing member is mounted to fins of the heat sink. That is, the fins are connected and fixed to one another through the fixing member. Accordingly, when noise from a PDP is transferred to the PBAs via a chassis base, the vibration of the fins of the heat sink is reduced, thereby reducing noise generated from the heat sink.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A plasma display device comprising:
a plasma display panel;
a chassis base attached to a surface of the plasma display panel;
a printed circuit board assembly mounted to the chassis base at a side opposite the plasma display panel and connected to the plasma display panel, the printed circuit board assembly having one or more circuit elements;
a heat sink attached to the one or more circuit elements, the heat sink having a plurality of fins extending away from the one or more circuit elements; and
a fixing member connecting and fixing free ends of the plurality of fins to one another.

2. The plasma display device of claim 1, wherein the fixing member is mounted to at least a corner of the free ends.

3. The plasma display device of claim 2, wherein the fixing member is mounted to each corner of the free ends.

4. The plasma display device of claim 1, wherein the fixing member is mounted to the free ends between opposing corners of the free ends.

5. The plasma display device of claim 1, wherein the fixing member includes a cover extending in a first direction orthogonal to a lengthwise direction of the fins with partitions formed at intervals along the first direction inside the cover.

6. The plasma display device of claim 5, wherein at least one corner of a cross section of the cover is formed in a shape corresponding to a corner of the free ends.

7. The plasma display device of claim 6, wherein the cross section of the cover is formed as a right triangle.

8. The plasma display device of claim 5, wherein a cross section of the cover is formed as a quadrilateral.

9. The plasma display device of claim 5, wherein a gap between the partitions corresponds to a thickness of each fin measured in the first direction.

10. The plasma display device of claim 5, wherein a thickness of each partition measured in the first direction corresponds to a gap between the fins.

11. The plasma display device of claim 1,
wherein the fixing member includes a cover extending in a first direction orthogonal to a lengthwise direction of the fins and partitions formed on the cover facing the fins, and
wherein engagement grooves are formed between the partitions and are adapted to engage respective free ends of the fins.

12. The plasma display device of claim 11, wherein the engagement grooves are formed in a shape corresponding to corners of the free ends.

13. The plasma display device of claim 1, wherein the fixing member is formed by injection molding of synthetic resins.

14. The plasma display device of claim 1, wherein the fixing member is fitted to the free ends of the fins.

15. The plasma display device of claim 1, wherein the printed circuit board assembly includes a sustain driving board for controlling sustain electrodes within the plasma display panel.

16. The plasma display device of claim 1, wherein the printed circuit board assembly includes a scan driving board for controlling scan electrodes within the plasma display panel.

17. The plasma display device of claim 1, wherein the circuit element includes a field effect transistor.

18. The plasma display device of claim 1, wherein the circuit element includes an intelligent power module.

19. A method of reducing noise generated by a heat sink having heat radiating fins, the method comprising mounting free ends of the heat radiating fins into engagement grooves of a fixing member, the fixing member fixedly connecting the free ends with one another.

20. A heat sink noise reducer for a heat sink having heat radiating fins, the heat sink noise reducer comprising a fixing member having a plurality of engagement grooves adapted to receive and fixedly connect free ends of the heat radiating fins.
